(19) United States
(12) Patent Application Publication
(10) Pub. No.: US 2014/0272794 A1
(43) Pub. Date: Sep. 18, 2014

(54) SURFACE MODIFIED DENTAL IMPLANT

(71) Applicant: Clarion University of Pennsylvania, Clarion, PA (US)

(72) Inventor: Benjamin Legum, Clarion, PA (US)

(73) Assignee: Clarion University of Pennsylvania, Clarion, PA (US)

(21) Appl. No.: 14/209,107

(22) Filed: Mar. 13, 2014

Related U.S. Application Data
(60) Provisional application No. 61/799,694, filed on Mar. 15, 2013.

(51) Int. Cl. A61C 8/00

(52) U.S. Cl. CPC A61C 8/0013; A61C 8/0022
USPC 433/174; 433/173; 427/2.26

(57) ABSTRACT

A dental implant provided herein includes a body including titanium or titanium alloy and a diamond-like coating on the body. The diamond-like coating has a surface kurtosis Rₖᵤ value of at least 1.5, a surface skewness Rₛₖ value of at least 1.2, or a combination thereof to have an increase in gingival cell adhesion to the implant in soft tissue surrounding the dental implant when a portion of the dental implant is implanted into a jaw bone.

### CLAIM OF PRIORITY

This application claims priority under 35 USC §119(e) to U.S. Provisional Application Ser. No. 61/799,694, filed on Mar. 15, 2013, the entire contents of which are hereby incorporated by reference.

### TECHNICAL FIELD

The document relates to dental implants having a pro-healing surface modification.

### BACKGROUND

Dental implants can be embedded into hard tissue (e.g., bone) act as structural support for restorations that resemble a tooth or group of teeth to replace missing teeth. Dental implants can be “root” device that appears similar to an actual tooth root. Some dental implants are made of titanium or titanium alloys. Some titanium dental implants are designed for interaction with hard tissue (e.g., bone). A jaw bone can accept and osseointegrate with the titanium dental implants. These titanium dental implants, however, also need to interact with soft tissue. Soft tissue surrounding a dental implant can take 1-2 months to heal, which can result in bacterial infections. Dental implant failure can be caused by combinations of mechanical stress, which causes the loosening of the bone and soft tissues, and the weakening of the hard tissue through exposure to infectious subgingival species. Accordingly, there is a need for a dental implant that can shorten the healing time for soft tissue therefore reducing the probability of bacterial infections.

### SUMMARY

A dental implant provided herein includes a body including titanium or titanium alloy and a diamond-like coating on the body. The diamond-like coating has structural deformations which increase in gingival cell adhesion to the implant in soft tissue surrounding the dental implant when a portion of the dental implant is implanted into a jaw bone. In some cases, a diamond-like coating provided herein can have a surface kurtosis Rₖᵤ value of at least 1.5, a surface skewness Rₛₖ value of at least 1.2, or a combination thereof. In some cases, the increase in gingival fibroblast cell adhesion can be at least 5%, at least 10%, at least 15%, or at least 18% when compared to titanium implant that does not have a coating.

A number of standard parameters are used to describe surface roughness of surfaces. These standard parameters include arithmetical mean deviation (Rₐ), Root mean square deviation Rroot mean square deviation (R_{q}), skewness (Rₛₖ), and kurtosis (Rₖᵤ). Arithmetical mean deviation, Rₐ, is the average of the individual heights (asperities) and the depths from the arithmetic mean elevation of the profile. Root mean square deviation R_{q}, is a square root of the sum of the squares of the individual heights and depths from the mean line. Skewness is a measure of symmetry, or more precisely, the lack of symmetry. Skewness, Rₛₖ, for a surface can be the average of the first derivative of the surface, which is the departure of the surface from symmetry. A negative value of Rₛₖ for a surface indicates that that surface is made up of valleys, whereinas a surface with a positive Rₛₖ value contains mainly peaks and asperites. Kurtosis is a measure of whether the data are peaked or flat relative to a normal distribution. For a surface, Kurtosis is a measure of the sharpness of the profile peaks. Rₐ, R_{q}, Rₛₖ, and Rₖᵤ can be calculated using the following equations:

$${R}_{a} = \frac{1}{mn} {\sum }_{k = 0}^{m - 1} {\sum }_{l = 0}^{n - 1} \vert Z ( {x}_{k} , {y}_{l} ) - μ \vert$$

$$Where , \\ μ = \frac{1}{mn} {\sum }_{k = 0}^{m - 1} {\sum }_{l = 0}^{n - 1} Z ( {x}_{k} , {y}_{l} )$$

$${R}_{q} = {( \frac{1}{mn} {\sum }_{k = 0}^{m - 1} {\sum }_{l = 0}^{n - 1} {( Z ( {x}_{k} , {y}_{l} ) - μ )}^{2} )}^{0.5}$$

$${R}_{sk} = \frac{1}{{mnR}_{q}^{3}} {\sum }_{k = 0}^{m - 1} {\sum }_{l = 0}^{n - 1} {( Z ( {x}_{k} , {y}_{l} ) - μ )}^{3}$$

$${R}_{ku} = \frac{1}{{mnR}_{q}^{4}} {\sum }_{k = 0}^{m - 1} {\sum }_{l = 0}^{n - 1} {( Z ( {x}_{k} , {y}_{l} ) - μ )}^{4}$$

A diamond like coating provided herein can include a skewness Rₛₖ value of at least 1.1. In some cases, a diamond like coating provided herein can include a skewness Rₛₖ value of at least 1.2. In some cases, a diamond like coating provided herein can include a skewness Rₛₖ value of at least 1.3. In some cases, a diamond like coating provided herein can include a skewness Rₛₖ value of at least 1.4. In some cases, a diamond like coating provided herein can include a skewness Rₛₖ value of less than 10. In some cases, a diamond like coating provided herein can include a skewness Rₛₖ value of less than 5. In some cases, a diamond like coating provided herein can include a skewness Rₛₖ value of less than 3. In some cases, a diamond like coating provided herein can include a skewness Rₛₖ value of less than 2. In some cases, a diamond like coating provided herein can include a skewness Rₛₖ value of less than 1.5. In some cases, a diamond like coating provided herein can include a skewness Rₛₖ value of between 1.1 and 10. In some cases, a diamond like coating provided herein can include a skewness Rₛₖ value of between 1.1 and 5. In some cases, a diamond like coating provided herein can include a skewness Rₛₖ value of between 1.1 and 2. In some cases, a diamond like coating provided herein can include a skewness Rₛₖ value of between 1.2 and 5. In some cases, a diamond like coating provided herein can include a skewness Rₛₖ value of between 1.3 and 2. In some cases, a diamond like coating provided herein can include a skewness Rₛₖ value of between 1.4 and 1.5. In some cases, a diamond like coating provided herein can include a skewness Rₛₖ value of between 1.2 and 2. In some cases, a diamond like coating provided herein can include a skewness Rₛₖ value of between 1.3 and 2.

A diamond-like coating provided herein can have a surface kurtosis Rₖᵤ value of at least 1.2. In some cases, a diamond-like coating provided herein can have a surface kurtosis Rₖᵤ value of at least 1.5. In some cases, a diamond-like coating provided herein can have a surface kurtosis Rₖᵤ value of at least 1.75. In some cases, a diamond-like coating provided herein can have a surface kurtosis Rₖᵤ value of at least 2.0. In some cases, a diamond-like coating provided herein can have a surface kurtosis Rₖᵤ value of at least 2.4. In some cases, a diamond-like coating provided herein can have a surface kurtosis Rₖᵤ value of at least 2.5. In some cases, a diamond-like coating provided herein can have a surface kurtosis Rₖᵤ value of less than 20. In some cases, a diamond-like coating provided herein can have a surface kurtosis Rₖᵤ value of less than 10. In some cases, a diamond-like coating provided herein can have a surface kurtosis Rₖᵤ value of less than 5. In some cases, a diamond-like coating provided herein can have a surface kurtosis Rₖᵤ value of less than 4. In some cases, a diamond-like coating provided herein can have a surface kurtosis Rₖᵤ value of less than 3. In some cases, a diamond-like coating provided herein can have a surface kurtosis Rₖᵤ value of less than 2.6. In some cases, a diamond-like coating provided herein can have a surface kurtosis Rₖᵤ value of between 1.1 and 20. In some cases, a diamond-like coating provided herein can have a surface kurtosis Rₖᵤ value of between 1.5 and 10. In some cases, a diamond-like coating provided herein can have a surface kurtosis Rₖᵤ value of between 1.75 and 5. In some cases, a diamond-like coating provided herein can have a surface kurtosis Rₖᵤ value of between 2.0 and 3. In some cases, a diamond-like coating provided herein can have a surface kurtosis Rₖᵤ value of between 2.4 and 2.6. In some cases, a diamond-like coating provided herein can have a surface kurtosis Rₖᵤ value of between 1.5 and 5. In some cases, a diamond-like coating provided herein can have a surface kurtosis Rₖᵤ value of between 1.5 and 3.0.

In some cases, a diamond-like coating provided herein can have an arithmetical mean deviation Rₐ of at least 65 microns. In some cases, a diamond-like coating provided herein can have an arithmetical mean deviation Rₐ of at least 70 microns. In some cases, a diamond-like coating provided herein can have an arithmetical mean deviation Rₐ of at least 75 microns. In some cases, a diamond-like coating provided herein can have an arithmetical mean deviation Rₐ of less than 1000 microns. In some cases, a diamond-like coating provided herein can have an arithmetical mean deviation Rₐ of less than 500 microns. In some cases, a diamond-like coating provided herein can have an arithmetical mean deviation Rₐ of less than 100 microns. In some cases, a diamond-like coating provided herein can have an arithmetical mean deviation Rₐ of less than 90 microns. In some cases, a diamond-like coating provided herein can have an arithmetical mean deviation Rₐ of less than 85 microns. In some cases, a diamond-like coating provided herein can have an arithmetical mean deviation Rₐ of between 65 microns and 100 microns. In some cases, a diamond-like coating provided herein can have an arithmetical mean deviation Rₐ of between 70 microns and 85 microns.

In some cases, a diamond-like coating provided herein can have a root mean square deviation R_{q} of at least 65 microns. In some cases, a diamond-like coating provided herein can have a root mean square deviation R_{q} of at least 70 microns. In some cases, a diamond-like coating provided herein can have a root mean square deviation R_{q} of at least 75 microns. In some cases, a diamond-like coating provided herein can have a root mean square deviation R_{q} of less than 1000 microns. In some cases, a diamond-like coating provided herein can have a root mean square deviation R_{q} of less than 500 microns. In some cases, a diamond-like coating provided herein can have a root mean square deviation R_{q} of less than 100 microns. In some cases, a diamond-like coating provided herein can have a root mean square deviation R_{q} of less than 95 microns. In some cases, a diamond-like coating provided herein can have a root mean square deviation R_{q} of less than 90 microns. In some cases, a diamond-like coating provided herein can have a root mean square deviation R_{q} of between 65 microns and 100 microns. In some cases, a diamond-like coating provided herein can have a root mean square deviation R_{q} of between 75 microns and 95 microns.

In some cases, a diamond-like coating provided herein can include at least 90% by weight carbon. In some cases, a diamond-like coating provided herein can include at least 93% by weight carbon. In some cases, a diamond-like coating provided herein can include at least 94% by weight carbon. In some cases, a diamond-like coating provided herein can include at least 95% by weight carbon. In some cases, a diamond-like coating provided herein can include less than 99% by weight carbon. In some cases, a diamond-like coating provided herein can include less than 98% by weight carbon. In some cases, a diamond-like coating provided herein can include less than 97% by weight carbon. In some cases, a diamond-like coating provided herein can include between 90% and 99% by weight carbon. In some cases, a diamond-like coating provided herein can include between 94% and 98% by weight carbon. In some cases, a diamond-like coating provided herein can include between 95% and 97% by weight carbon.

In some cases, a diamond-like coating provided herein can include at least 1% by weight oxygen. In some cases, a diamond-like coating provided herein can include at least 2% by weight oxygen. In some cases, a diamond-like coating provided herein can include at least 3% by weight oxygen. In some cases, a diamond-like coating provided herein can include less than 10% by weight oxygen. In some cases, a diamond-like coating provided herein can include less than 7% by weight oxygen. In some cases, a diamond-like coating provided herein can include less than 5% by weight oxygen. In some cases, a diamond-like coating provided herein can include between 1% and 10% by weight oxygen. In some cases, a diamond-like coating provided herein can include between 2% and 7% by weight oxygen. In some cases, a diamond-like coating provided herein can include between 3% and 5% by weight oxygen. In some cases, a diamond-like coating provided herein can include about 96% by weight carbon and about 4% by weight oxygen.

In another aspect, the invention features a method of forming a diamond-like coating on a dental implant. The method provided herein includes removing native oxides from a surface of a dental implant, forming an amorphous carbon coating on the dental implant, and annealing the dental implant to create a diamond-like coating provided herein. Native oxides can be removed by applying hydrofluoric acid to the dental implant. The amorphous carbon coating can be formed by holding the dental implant at a temperature of at least 700° C. for at least 30 minutes in an environment including methane (e.g., an environment including Argon and methane). The dental implant can be annealed under inert conditions at a temperature of at least 900° C. for at least 1 hour to create a diamond-like coating. In some cases, a diamond-like coating on a dental implant can be confined to portions of the dental implant that contact (or that are likely to contact) soft tissue when implanted. In some cases, a diamond-like coating provided herein on a threaded dental implant are limited to portions of the implant above a threaded portion of the implant.

The details of certain dental implants provided herein are set forth in the accompanying drawings and the description below. Other features, objects, and advantages of the dental implants provided herein will be apparent from the description and drawings, and from the claims.

### DESCRIPTION OF DRAWINGS

FIGS. 1A-1D depict an example of a dental implant.

FIGS. 2A-2D micrographs of diamond-like coating morphologies.

FIGS. 3A-3B are surface plots of diamond-like coatings.

FIG. 3C is a surface plot of a polished titanium alloy.

Like reference symbols in the various drawings indicate like elements.

### DETAILED DESCRIPTION

Referring to FIGS. 1A-1D, an example of a dental implant 100 provided herein is shown implanted into a jaw J of a patient in order to secure artificial teeth D in the patient's mouth. Although FIGS. 1A-1D depict a particular dental implant design, other dental implant designs are also contemplated. The dental implant 100 can include a post portion 110 and a head portion 120. The post portion 110 can be implanted into a jaw bone B. As shown, the post portion 100 can include threads, which can facilitate the process of screwing the dental implant 100 into the jaw bone B. Portions of the dental implant 100, however, also contact soft tissue S. In some cases, surfaces of the head portion 120 can contact soft tissue S. As shown in FIG. 1C, a dental implant provided herein can also include a ring 130 can be placed over the head portion 120. The ring can also contact soft tissue S. As shown in FIG. 1D, artificial teeth D can be secured to head portions of a plurality of dental implants provided herein. In some cases, individual artificial teeth can be secured to a jaw J using a dental implant provided herein, such as dental implant 100 as shown in FIG. 1A or FIG. 1C.

One or more surfaces of dental implant 100 can include a diamond-like coating provided herein. In some cases, ring 130 of dental implant 100 includes a diamond-like coating provided herein. In some cases, a head portion 120 includes a diamond-like coating provided herein. In some cases, all surfaces of the dental implant 100, including the post portion 110, include a diamond-like coating provided herein. In some cases, the diamond-like coating is selectively coated along a portion of the dental implant that would be expected to contact soft tissue S when a post portion is implanted into a jaw bone B. In some cases, the diamond-like coating is selectively coated above the thread on the post portion 110.

The dental implant provided herein can include titanium or titanium alloy. Commercially pure titanium can have low to medium levels of oxygen and other trace elements. In some cases, the dental implant is made with titanium alloy. In some cases, titanium alloys used in a dental implant provided herein can include aluminum, vanadium, palladium, molybdenum, iron, nickel, ruthenium, chromium, zirconium, niobium, silicon, or a combination thereof. In some cases, the alloy includes about 6 weight percent aluminum, about 4 weight percent vanadium, a maximum of 0.25 weight percent iron, a maximum of 0.2 weight percent oxygen, and the remainder titanium. This alloy is sometimes known as Ti-6Al-4V or Grade 5 Titanium. In some cases, a dental implant provided herein includes Ti-6Al-4V, Ti-0.05Pd, Ti-0.15Pd, Ti-0.25Pd, Ti-6Al-7Nb, Ti-5Al-2.5Sn, Ti-0.2Mn-0.8Ni, Ti-3Al-2.5V-0.05Pd, Ti-3Al-8V-6Cr-4Zr-4Mn, Ti-15Mn-3MA-2.7Nb-0.25Si, or a combination thereof. In some cases, the titanium alloy can have a density of between 4000 and 5000 kg/m³, Young's modulus of between 80 GPa and 150 GPa, and tensile strength of between 800 MPa and 1500 MPa.

Magnified views of diamond-like coatings provided herein are shown in FIGS. 2A-2D. FIG. 2A is at 1119×, FIG. 2B is at 2073×, FIG. 2C is at 4194×, and FIG. 2D is at 7127×. FIG. 3A depicts 3-D plot of the surface of FIG. 2A. FIG. 3B depicts 3-D plot of the surface of FIG. 2B. FIG. 3C depicts 3-D plot of a polished Ti-6Al-4V alloy.

A number of standard parameters are used to describe surface roughness of surfaces. These standard parameters include arithmetical mean deviation (Rₐ), root mean square deviation (R_{q}), skewness (Rₛₖ), and kurtosis (Rₖᵤ). Arithmetical mean deviation Rₐ is the average of the individual heights (asperities) and the depths from the arithmetic mean elevation of the profile. Root mean square deviation R_{q} is a square root of the sum of the squares of the individual heights and depths from the mean line. Skewness is a measure of symmetry, or more precisely, the lack of symmetry. Skewness Rₛₖ for a surface can be the average of the first derivative of the surface, which is the departure of the surface from symmetry. A negative value of Rₛₖ for a surface indicates that that surface is made up of valleys, whereinas a surface with a positive Rₛₖ value contains mainly peaks and asperites. Kurtosis is a measure of whether the data are peaked or flat relative to a normal distribution. For a surface, Kurtosis is a measure of the sharpness of the profile peaks. Rₐ, R_{q}, Rₛₖ, and Rₖᵤ can be calculated using the following equations:

$${R}_{a} = \frac{1}{mn} {\sum }_{k = 0}^{m - 1} {\sum }_{l = 0}^{n - 1} \vert Z ( {x}_{k} , {y}_{l} ) - μ \vert$$

$$Where , \\ μ = \frac{1}{mn} {\sum }_{k = 0}^{m - 1} {\sum }_{l = 0}^{n - 1} Z ( {x}_{k} , {y}_{l} )$$

$${R}_{q} = {( \frac{1}{mn} {\sum }_{k = 0}^{m - 1} {\sum }_{l = 0}^{n - 1} {( Z ( {x}_{k} , {y}_{l} ) - μ )}^{2} )}^{0.5}$$

$${R}_{sk} = \frac{1}{{mnR}_{q}^{3}} {\sum }_{k = 0}^{m - 1} {\sum }_{l = 0}^{n - 1} {( Z ( {x}_{k} , {y}_{l} ) - μ )}^{3}$$

$${R}_{ku } = \frac{1}{{mnR}_{q}^{4}} {\sum }_{k = 0}^{m - 1} {\sum }_{l = 0}^{n - 1} {( Z ( {x}_{k} , {y}_{l} ) - μ )}^{4}$$

The diamond-like coatings shown in FIGS. 2A-2D were evaluated to determine the Rₐ, R_{q}, Rₛₖ, and Rₖᵤ for the surface shown in each image. This data was compared to polished and unpolished samples of Ti-6Al-4V alloy. Additionally, a highest peak, lowest vally and total height was determined for each sample. The data is shown in Table 1.

TABLE 1

| | | | | | Highest | Lowest | Total |
|---|---|---|---|---|---|---|---|
| | R_{q} | Rₐ | Rₛₖ | Rₖᵤ | Peak | Valley | Height |
| | (microns) | (microns) | (no units) | (no units) | (microns) | (microns) | (microns) |
| FIG. 2A | 81.972 | 71.98 | 1.461 | 2.582 | 250 | 13 | 263 |
| 50 micron | 79.457 | 70.545 | 1.444 | 2.558 | 250 | 13 | 263 |
| section of | | | | | | | |
| FIG. 2A | | | | | | | |
| FIG. 2B | 80.056 | 70.831 | 1.444 | 2.537 | 250 | 13 | 263 |
| 100 micron | 82.593 | 73.07 | 1.428 | 2.439 | 250 | 13 | 263 |
| section of | | | | | | | |
| FIG. 2B | | | | | | | |
| FIG. 2C | 81.394 | 73.218 | 1.359 | 2.141 | 255 | 20 | 275 |
| FIG. 2D | 92.132 | 82.412 | 1.355 | 2.109 | 255 | 19 | 274 |
| Ti6Al4V | 73.333 | 73.24 | 1.002 | 1.007 | 113 | 60 | 173 |
| polished | | | | | | | |
| sample 1 | | | | | | | |
| Ti6Al4V | 73.426 | 73.338 | 1.005 | 1.006 | 113 | 60 | 173 |
| polished | | | | | | | |
| sample 2 | | | | | | | |
| Ti6Al4V | 58.805 | 58.574 | 1.014 | 1.03 | 110 | 32 | 142 |
| unpolished | | | | | | | |
| sample 1 | | | | | | | |
| Ti6Al4V | 62.018 | 61.727 | 1.009 | 1.02 | 134 | 33 | 167 |
| unpolished | | | | | | | |
| sample 2 | | | | | | | |

A diamond like coating provided herein can include a skewness Rₛₖ value of at least 1.1. In some cases, a diamond like coating provided herein can include a skewness Rₛₖ value of at least 1.2. In some cases, a diamond like coating provided herein can include a skewness Rₛₖ value of at least 1.3. In some cases, a diamond like coating provided herein can include a skewness Rₛₖ value of at least 1.4. In some cases, a diamond like coating provided herein can include a skewness Rₛₖ value of less than 10. In some cases, a diamond like coating provided herein can include a skewness Rₛₖ value of less than 5. In some cases, a diamond like coating provided herein can include a skewness Rₛₖ value of less than 3. In some cases, a diamond like coating provided herein can include a skewness Rₛₖ value of less than 2. In some cases, a diamond like coating provided herein can include a skewness Rₛₖ value of less than 1.5. In some cases, a diamond like coating provided herein can include a skewness Rₛₖ value of between 1.1 and 10. In some cases, a diamond like coating provided herein can include a skewness Rₛₖ value of between 1.1 and 5. In some cases, a diamond like coating provided herein can include a skewness Rₛₖ value of between 1.1 and 2. In some cases, a diamond like coating provided herein can include a skewness Rₛₖ value of between 1.2 and 5. In some cases, a diamond like coating provided herein can include a skewness Rₛₖ value of between 1.3 and 2. In some cases, a diamond like coating provided herein can include a skewness Rₛₖ value of between 1.4 and 1.5. In some cases, a diamond like coating provided herein can include a skewness Rₛₖ value of between 1.2 and 2. In some cases, a diamond like coating provided herein can include a skewness Rₛₖ value of between 1.3 and 2.

In some cases, a diamond-like coating provided herein can have a highest peak of at least 100 microns. In some cases, a diamond-like coating provided herein can have a highest peak of at least 150 microns. In some cases, a diamond-like coating provided herein can have a highest peak of at least 200 microns. In some cases, a diamond-like coating provided herein can have a highest peak of at least 250 microns. In some cases, a diamond-like coating provided herein can have a highest peak of less than 1000 microns. In some cases, a diamond-like coating provided herein can have a highest peak of less than 500 microns. In some cases, a diamond-like coating provided herein can have a highest peak of less than 300 microns. In some cases, a diamond-like coating provided herein can have a highest peak of less than 250 microns. In some cases, a diamond-like coating provided herein can have a highest peak of between 150 microns and 500 microns. In some cases, a diamond-like coating provided herein can have a highest peak of between 200 microns and 300 microns. In some cases, a diamond-like coating provided herein can have a lowest valley depth of less than 50 microns. In some cases, a diamond-like coating provided herein can have a lowest valley depth of less than 30 microns. In some cases, a diamond-like coating provided herein can have a lowest valley depth of less than 20 microns. In some cases, a diamond-like coating provided herein can have a lowest valley depth of less than 15 microns. In some cases, a diamond-like coating provided herein can have a lowest valley depth of at least 5 microns. In some cases, a diamond-like coating provided herein can have a lowest valley depth of at least 10 microns. In some cases, a diamond-like coating provided herein can have a lowest valley depth of between 5 microns and 50 microns. In some cases, a diamond-like coating provided herein can have a lowest valley depth of between 10 microns and 15 microns. In some cases, a diamond-like coating provided herein can have a ratio of highest peak to lowest valley depth of at least 3. In some cases, a diamond-like coating provided herein can have a ratio of highest peak to lowest valley depth of at least 5. In some cases, a diamond-like coating provided herein can have a ratio of highest peak to lowest valley depth of at least 10. In some cases, a diamond-like coating provided herein can have a ratio of highest peak to lowest valley depth of at least 15. In some cases, a diamond-like coating provided herein can have a ratio of highest peak to lowest valley depth of less than 100. In some cases, a diamond-like coating provided herein can have a ratio of highest peak to lowest valley depth of less than 50. In some cases, a diamond-like coating provided herein can have a ratio of highest peak to lowest valley depth of less than 20. In some cases, a diamond-like coating provided herein can have a ratio of highest peak to lowest valley depth of between 3 and 100. In some cases, a diamond-like coating provided herein can have a ratio of highest peak to lowest valley depth of between 10 and 50. In some cases, a diamond-like coating provided herein can have a ratio of highest peak to lowest valley depth of between 15 and 20. In some cases, a diamond-like coating provided herein can have a total height (highest peak+lowest valley depth) is at least 200 microns. In some cases, the total height is at least 250 microns. In some cases, the total height is less than 1000 microns. In some cases, the total height is less than 500 microns. In some cases, the total height is less than 300 microns. In some cases, the total height is between 200 microns and 500 microns.

A diamond-like coating provided herein can have a surface kurtosis Rₖᵤ value of at least 1.2. In some cases, a diamond-like coating provided herein can have a surface kurtosis Rₖᵤ value of at least 1.5. In some cases, a diamond-like coating provided herein can have a surface kurtosis Rₖᵤ value of at least 1.75. In some cases, a diamond-like coating provided herein can have a surface kurtosis Rₖᵤ value of at least 2.0. In some cases, a diamond-like coating provided herein can have a surface kurtosis Rₖᵤ value of at least 2.4. In some cases, a diamond-like coating provided herein can have a surface kurtosis Rₖᵤ value of at least 2.5. In some cases, a diamond-like coating provided herein can have a surface kurtosis Rₖᵤ value of less than 20. In some cases, a diamond-like coating provided herein can have a surface kurtosis Rₖᵤ value of less than 10. In some cases, a diamond-like coating provided herein can have a surface kurtosis Rₖᵤ value of less than 5. In some cases, a diamond-like coating provided herein can have a surface kurtosis Rₖᵤ value of less than 4. In some cases, a diamond-like coating provided herein can have a surface kurtosis Rₖᵤ value of less than 3. In some cases, a diamond-like coating provided herein can have a surface kurtosis Rₖᵤ value of less than 2.6. In some cases, a diamond-like coating provided herein can have a surface kurtosis Rₖᵤ value of between 1.1 and 20. In some cases, a diamond-like coating provided herein can have a surface kurtosis Rₖᵤ value of between 1.5 and 10. In some cases, a diamond-like coating provided herein can have a surface kurtosis Rₖᵤ value of between 1.75 and 5. In some cases, a diamond-like coating provided herein can have a surface kurtosis Rₖᵤ value of between 2.0 and 3. In some cases, a diamond-like coating provided herein can have a surface kurtosis Rₖᵤ value of between 2.4 and 2.6. In some cases, a diamond-like coating provided herein can have a surface kurtosis Rₖᵤ value of between 1.5 and 5. In some cases, a diamond-like coating provided herein can have a surface kurtosis Rₖᵤ value of between 1.5 and 3.0.

In some cases, a diamond-like coating provided herein can have an arithmetical mean deviation Rₐ of at least 65 microns. In some cases, a diamond-like coating provided herein can have an arithmetical mean deviation Rₐ of at least 70 microns. In some cases, a diamond-like coating provided herein can have an arithmetical mean deviation Rₐ of at least 75 microns. In some cases, a diamond-like coating provided herein can have an arithmetical mean deviation Rₐ of less than 1000 microns. In some cases, a diamond-like coating provided herein can have an arithmetical mean deviation Rₐ of less than 500 microns. In some cases, a diamond-like coating provided herein can have an arithmetical mean deviation Rₐ of less than 100 microns. In some cases, a diamond-like coating provided herein can have an arithmetical mean deviation Rₐ of less than 90 microns. In some cases, a diamond-like coating provided herein can have an arithmetical mean deviation Rₐ of less than 85 microns. In some cases, a diamond-like coating provided herein can have an arithmetical mean deviation Rₐ of between 65 microns and 100 microns. In some cases, a diamond-like coating provided herein can have an arithmetical mean deviation Rₐ of between 70 microns and 85 microns.

In some cases, a diamond-like coating provided herein can have a root mean square deviation R_{q} of at least 65 microns. In some cases, a diamond-like coating provided herein can have a root mean square deviation R_{q} of at least 70 microns. In some cases, a diamond-like coating provided herein can have a root mean square deviation R_{q} of at least 75 microns. In some cases, a diamond-like coating provided herein can have a root mean square deviation R_{q} of less than 1000 microns. In some cases, a diamond-like coating provided herein can have a root mean square deviation R_{q} of less than 500 microns. In some cases, a diamond-like coating provided herein can have a root mean square deviation R_{q} of less than 100 microns. In some cases, a diamond-like coating provided herein can have a root mean square deviation R_{q} of less than 95 microns. In some cases, a diamond-like coating provided herein can have a root mean square deviation R_{q} of less than 90 microns. In some cases, a diamond-like coating provided herein can have a root mean square deviation R_{q} of between 65 and 100 microns. In some cases, a diamond-like coating provided herein can have a root mean square deviation R_{q} of between 75 and 95 microns.

In some cases, a diamond-like coating provided herein can include at least 90% by weight carbon. In some cases, a diamond-like coating provided herein can include at least 93% by weight carbon. In some cases, a diamond-like coating provided herein can include at least 94% by weight carbon. In some cases, a diamond-like coating provided herein can include at least 95% by weight carbon. In some cases, a diamond-like coating provided herein can include less than 99% by weight carbon. In some cases, a diamond-like coating provided herein can include less than 98% by weight carbon. In some cases, a diamond-like coating provided herein can include less than 97% by weight carbon. In some cases, a diamond-like coating provided herein can include between 90% and 99% by weight carbon. In some cases, a diamond-like coating provided herein can include between 94% and 98% by weight carbon. In some cases, a diamond-like coating provided herein can include between 95% and 97% by weight carbon.

In some cases, a diamond-like coating provided herein can include at least 1% by weight oxygen. In some cases, a diamond-like coating provided herein can include at least 2% by weight oxygen. In some cases, a diamond-like coating provided herein can include at least 3% by weight oxygen. In some cases, a diamond-like coating provided herein can include less than 10% by weight oxygen. In some cases, a diamond-like coating provided herein can include less than 7% by weight oxygen. In some cases, a diamond-like coating provided herein can include less than 5% by weight oxygen. In some cases, a diamond-like coating provided herein can include between 1% and 10% by weight oxygen. In some cases, a diamond-like coating provided herein can include between 2% and 7% by weight oxygen. In some cases, a diamond-like coating provided herein can include between 3% and 5% by weight oxygen. In some cases, a diamond-like coating provided herein can include about 96% by weight carbon and about 4% by weight oxygen.

A diamond-like coating provided herein can be made on a dental implant by cleaning the dental implant, adding an oxide layer, depositing an amorphous carbon coating, and annealing to form the diamond-like coating. The dental implant can be cleaned using acetone, isopropyl alcohol, water, or a combination thereof. The water can be deionized. In some cases, other cleaning agents can be used to clean and polish a dental implant. In some cases, the cleaning process is optional. Native oxides can be added by placing the dental implant in hydrofluoric acid. The dental implant can be exposure to hydrofluoric acid for any length of time. In some cases, one or more dental implants are dipped into a solution of hydrofluoric acid for at about 15 seconds, about 30 seconds, about 45 seconds, or about 1 minute. An oxide layer created by dipping the implant in hydrofluoric acid can promote the creation of a diamond-like coating provided herein. After dipping in hydrofluoric acid, the dental implant can be neutralized. For example, deionized water can be used to wash the dental implant(s). An amorphous carbon coating can be made by contacting the dental implant with a methane atmosphere at a temperature of at least 700° C. for at least 30 minutes. For example, a dental implant can be placed in an atmospheric pressure chemical vapor deposition (APCVD) furnace, the APCVD furnace can be heated to 875° C. with an inflow of noble gas (e.g., Argon), after reaching 875° C., the flow of Argon can stop and an inflow of methane gas at 0.2 slpm can be introduced into the APCVD furnace for about 1 hour, the methane gas flow can stop and be replaced noble gas (e.g., Argon) and the APCVD furnace cooled. The amouphous carbon coating can be converted into a diamond-like coating provided herein by annealing at a temperature of at least 900° C. for at least an hour. For example, a dental implant having an amorphous carbon coating can be placed in a tube furnace, the tube furnace heated to 1100° C. with a noble gas inflow starting before the furnace exceeds 400° C., held at a temperature of at least 1100° C. for 3 hours, and cooling the furnace. Diamond-like coatings such as those shown in FIGS. 2A-2D were produced using this procedure.

Tests of titanium wafers including a diamond-like coating provided herein demonstrated a 19% increase in gingival fibroblast adhesion. The surface structure of a diamond-like coating provided herein can improve the gingival fibroblast adhesion by providing an appropriate surface density (roughness) that is conducive to cell adhesion molecule adhesion. The additional research conducted concluded reproducibility of the coating with the same specifications and ranges. Repeated biological testing concluded an increase of cell adhesion from the traditional implant grade Ti₆Al₄V of up to 19%. The cell lines tested were human fibroblasts (HGF-1, provided by ATCC) and primary human gingival cells (HGEP, provided by Cellntec).

A dental implant provided herein can also include a therapeutic agent. The terms “therapeutic agent”, “pharmaceutically active agent”, “pharmaceutically active material”, “pharmaceutically active ingredient”, “drug” and other related terms may be used interchangeably herein and include, but are not limited to, small organic molecules, peptides, oligopeptides, proteins, nucleic acids, oligonucleotides, genetic therapeutic agents, non-genetic therapeutic agents, vectors for delivery of genetic therapeutic agents, cells, and therapeutic agents identified as candidates for vascular treatment regimens, for example, as agents that reduce or inhibit restenosis. For example, a drug or drug group can be bonded to the diamond-like coating. In some cases, a drug can be coated onto the dental implant. Exemplary therapeutic agents include, e.g., anti-thrombogenic agents (e.g., heparin); anti-proliferative/anti-mitotic agents (e.g., paclitaxel, 5-fluorouracil, cisplatin, vinblastine, vincristine, inhibitors of smooth muscle cell proliferation (e.g., monoclonal antibodies), and thymidine kinase inhibitors); antioxidants; anti-inflammatory agents (e.g., dexamethasone, prednisolone, corticosterone); anesthetic agents (e.g., lidocaine, bupivacaine and ropivacaine); anti-coagulants; antibiotics (e.g., erythromycin, triclosan, cephalosporins, and aminoglycosides); agents that stimulate endothelial cell growth and/or attachment. Therapeutic agents can be nonionic, or they can be anionic and/or cationic in nature. Therapeutic agents can be used singularly, or in combination.

All publications, patent applications, patents, and other references mentioned herein are incorporated by reference herein in their entirety.

Still further embodiments are in the following claims.

What is claimed is:

1. A dental implant, comprising:
a body comprising titanium or titanium alloy,
a diamond-like coating on the body, the diamond-like coating having a surface kurtosis Rₖᵤ value of at least 1.5 to have an increase in gingival cell adhesion to the implant in soft tissue surrounding the dental implant when a portion of the dental implant is implanted into a jaw bone.

2. A dental implant, comprising:
a body comprising titanium or titanium alloy,
a diamond-like coating on the body, the diamond-like coating having a surface skewness Rₛₖ value of at least 1.2 to have an increase in gingival cell adhesion to the implant in soft tissue surrounding the dental implant when a portion of the dental implant is implanted into a jaw bone.

3. The dental implant of claim 1, wherein body comprises titanium alloy comprising titanium, aluminum, and vanadium.

4. The dental implant of claim 3, wherein titanium alloy consists of about 6 weight percent aluminum, about 4 weight percent vanadium, a maximum of 0.25 weight percent iron, a maximum of 0.2 weight percent oxygen, and a balance of titanium.

5. The dental implant of claim 1, wherein the dental implant comprises a post adapted to be implanted in a jaw bone.

6. The dental implant of claim 1, wherein the dental implant comprises a thread and is adapted to be screwed into a jaw bone.

7. The dental implant of claim 1, wherein the dental implant comprises a ring.

8. The dental implant of claim 1, wherein the diamond-like coating has a surface kurtosis Rₖᵤ value of at least 2.0.

9. The dental implant of claim 1, wherein the diamond-like coating has a surface skewness Rₛₖ value of at least 1.4.

10. The dental implant of claim 1, wherein the diamond-like coating comprises between about 95% and about 97% by weight carbon and between about 3% and about 5% by weight oxygen.

11. The dental implant of claim 1, wherein the diamond-like coating comprises a therapeutic agent.

12. A method of forming a pro-healing coating on a dental implant, comprising:
adding oxides to a surface of a dental implant by exposing the surface to an acid, the dental implant comprising titanium or titanium alloy;
forming an amorphous carbon coating on the dental implant by holding the dental implant at a temperature of at least 700° C. for at least 30 minutes in an atmosphere comprising methane; and
annealing the dental implant having the amorphous carbon coating at a temperature of at least 900° C. for at least 1 hour to create a diamond-like coating having a surface kurtosis Rₖᵤ value of at least 1.5, a surface skewness Rₛₖ value of at least 1.2, or a combination thereof.

13. The method of claim 12, further comprising cleaning a dental implant with acetone, isopropyl alcohol, water, or a combination thereof prior to removing native oxides from the dental implant.

14. The method of claim 12, wherein the amorphous carbon coating is deposited by placing the dental implant in a furnace in a noble gas atmosphere, heating the furnace to between 800° C. and 1000° C., introducing methane into the furnace, holding the temperature of the furnace above 800° C. for at least one hour after introducing methane into the furnace, and cooling the furnace.

15. The method of claim 12, wherein the dental implant is annealed by placing the dental implant having the amorphous carbon coating in a furnace, heating the furnace to a temperature of between 1000° C. and 1300° C. in a noble gas atmosphere, maintain temperature of above 800° C. for between 2 hours and 5 hours, and cool the furnace.

16. The method of claim 12, wherein the dental implant comprises a titanium alloy that consists of about 6 weight percent aluminum, about 4 weight percent vanadium, a maximum of 0.25 weight percent iron, a maximum of 0.2 weight percent oxygen, and a balance of titanium.

17. The method of claim 12, wherein the dental implant comprises a post, a threaded post, a ring, or a combination thereof.

18. The method of claim 12, wherein the diamond-like coating has a surface kurtosis Rₖᵤ value of at least 2.0, a surface skewness Rₛₖ value of at least 1.4, or a combination thereof.

19. The method of claim 12, wherein the diamond-like coating comprises between about 95% and about 97% by weight carbon and between about 3% and about 5% by weight oxygen.

20. A dental implant, comprising:
a body comprising titanium or titanium alloy,
a diamond-like coating on the body, the diamond-like coating comprising comprises between about 95% and about 97% by weight carbon and between about 3% and about 5% by weight oxygen, the diamond-like coating having a surface kurtosis Rₖᵤ value of between 1.5 and 3.0, a surface skewness Rₛₖ value of between 1.2 and 2.0, an average surface roughness Rₐ of between 65 and 100, a root mean square deviation R_{q} 0roughness of between 65 and 100.
